(19) United States
(12) Patent Application Publication
(10) Pub. No.: US 2011/0120031 A1
(43) Pub. Date: May 26, 2011

(54) WINDOW INSULATION PANEL

(76) Inventor: Glenn R. Scherba, Aurora, OH (US)

(21) Appl. No.: 12/951,688

(22) Filed: Nov. 22, 2010

Related U.S. Application Data
(60) Provisional application No. 61/263,016, filed on Nov. 20, 2009.

(51) Int. Cl. E06B 3/263; E04C 2/20; B23P 17/04

(52) U.S. Cl. 52/202; 52/309.1; 29/428

(57) ABSTRACT

A window insulation panel and method of constructing the window insulation panels is provided. The window insulation panel includes an exterior insulation panel, an interior insulation panel and a plurality of enclosed chambers disposed therebetween. The plurality of enclosed chambers are filled with aerogel.

### CROSS-REFERENCE TO RELATED APPLICATIONS

This application claims the benefit of U.S. Provisional patent application No. 61/263,016 filed on Nov. 20, 2009 which is incorporated herein by reference.

### TECHNICAL FIELD OF THE INVENTION

The present invention relates generally to a window insulation panel, and more particularly to a window insulation panel that may be mounted and subsequently removed from a window.

### BACKGROUND OF THE INVENTION

For residents of both temperate and colder climates, the cost of heating indoor premises during the winter months represents a yearly and increasingly onerous expenditure. Ordinary window installations are not thermally optimized, allowing heated air to escape and the transfer of the cold outside air into the indoor premises. The inefficiencies of typical window installations significantly increase the cost and effort required to heat indoor spaces.

Moreover, in recent years we have recognized the broader environmental impacts of the problem of energy inefficient windows, with tax credits available to purchasers of windows that meet certain energy efficiency benchmarks. Traditional approaches to this problem have achieved inconsistent results. Thermally optimized windows can minimize heat loss but are often very costly. Adding significantly to the base cost of this approach is the steep price of installation and the inconvenience caused by this process. Moreover such prior art window installations provide little possibility for customization.

Storm windows suggest a different solution by allowing the replacement of a screen window with a solid glass or plastic sheet. This provides an additional layer of insulation between outdoor and indoor spaces. Such installations do not achieve substantial thermal insulation because the materials and construction of these devices generally favor affordability and convenience over thermally effectiveness.

The present invention addresses these issues by providing a convenient, cost effective and retrofittable solution that also boasts high thermal performance.

### SUMMARY OF THE INVENTION

According to the present invention, there is provided a window insulation panel constructed of an exterior insulation panel spaced from an interior insulation panel and joined thereto; at least one enclosed chamber is disposed between the exterior and interior insulation panels; and the at least one enclosed chamber is filled with aerogel.

Further according to the present invention, there is provided a window insulation panel having an exterior insulation panel spaced from an interior insulation panel; an intermediate insulation panel disposed medially between interior and exterior insulation panels; a plurality of enclosed chambers disposed between the exterior and interior insulation panels; and the plurality of enclosed chambers being filled with aerogel.

Still further according to the present invention, there is provided a method of constructing a window insulation panel. The method includes joining an exterior insulation panel in spaced relationship to an interior insulation panel; forming at least one enclosed chamber between the exterior and interior insulation panels; and filling the at least one enclosed chamber being filled with aerogel.

### BRIEF DESCRIPTION OF THE DRAWINGS

The structure, operation, and advantages of the present invention will become further apparent upon consideration of the following description taken in conjunction with the accompanying figures (FIGS.). The figures are intended to be illustrative, not limiting. Certain elements in some of the figures may be omitted, or illustrated not-to-scale, for illustrative clarity. The cross-sectional views may be in the form of “slices”, or “near-sighted” cross-sectional views, omitting certain background lines which would otherwise be visible in a “true” cross-sectional view, for illustrative clarity.

FIG. 1 is a perspective view illustrating a window insulation panel installed on the inside portion of a window installation, in accordance with the present invention.

FIG. 2 is a cutaway view, in cross section, of the window insulation panel installed on the inside portion of a window installation, in accordance with the present invention.

FIG. 3 is a top view, in cross section, of the window insulation panel through line 3-3 of FIG. 1, in accordance with the present invention.

FIG. 4 is a perspective exploded view illustrating another embodiment of a window insulation panel, in accordance with the present invention.

FIG. 5 is a partial top view, in cross section, of the window insulation panel of FIG. 4 having a double layer of aerogel-filled spaces, in accordance with the present invention.

### DETAILED DESCRIPTION OF THE PREFERRED EMBODIMENTS

In the description that follows, numerous details are set forth in order to provide a thorough understanding of the present invention. It will be appreciated by those skilled in the art that variations of these specific details are possible while still achieving the results of the present invention. Well-known processing steps are generally not described in detail in order to avoid unnecessarily obfuscating the description of the present invention.

In the description that follows, exemplary dimensions may be presented for an illustrative embodiment of the invention. The dimensions should not be interpreted as limiting. They are included to provide a sense of proportion. Generally speaking, it is the relationship between various elements, where they are located, their contrasting compositions, and sometimes their relative sizes that is of significance.

In the drawings accompanying the description that follows, often both reference numerals and legends (labels, text descriptions) will be used to identify elements. If legends are provided, they are intended merely as an aid to the reader, and should not in any way be interpreted as limiting.

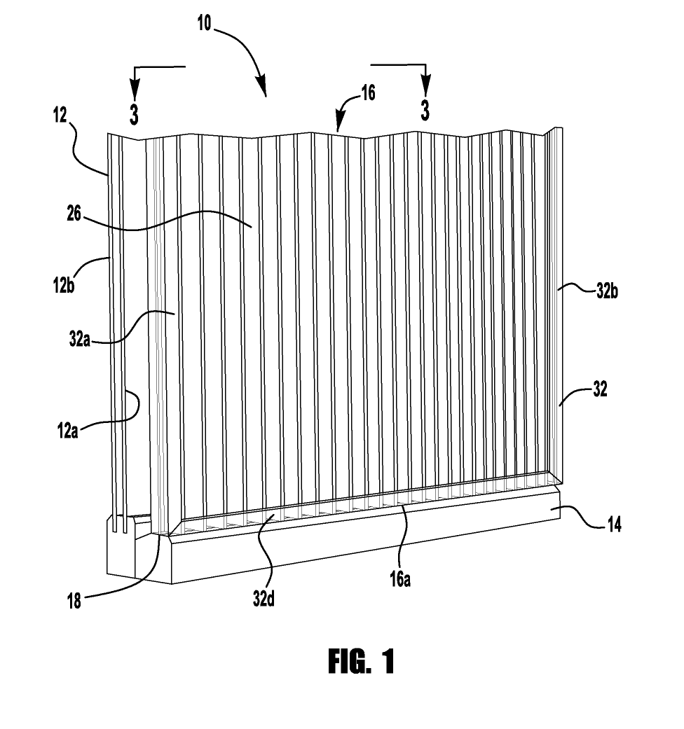

Referring to FIG. 1, there is shown a portion of a window system 10 having a double paned window 12 and a screen window frame 14 disposed on the interior side 12a of the double paned window 12. A window insulation panel 16 is disposed within the screen window frame 14 of window system 10. While a double paned window 12 is illustrated, it is within the terms of the present invention for any type of window to be used in combination with the window insulation panel 16 of the present invention. The window insulation panel 16 is constructed of a size such that it can fit on a shoulder 18 or groove (not shown) of the screen window frame 14 and thereby help prevent the flow of air from the exterior side 12b of the double paned window 12 and interstitial space 22, formed between the window insulation panel 16 and the existing window double paned 16. The window insulation panel 16 can be secured in place on shoulder 18 or within grooves that are provided across either side of the window insulation panel. It is also within the terms of the invention to support the window insulation panel 16 by any means such as brackets, glue, or Velcro between the edges of side of the insulation panel and the window opening. It is also within the terms of the present invention for the window insulation panel to be free standing so that it can be placed in front of, behind or within any opening where one wants to reduce the heat transfer from one side of the opening to the other side.

It is also within the terms of the present invention for the window insulation panel 16 to be installed as part of a skylight installation (not shown). Moreover, it is within the terms of the present invention for the window insulation panel 16 to be installed in any window opening whereby some unobstructed space of ½ inch or greater is provided between the window and the window insulation panel.

The window insulation panel 16 is formed of an interior insulation panel 24 and an exterior insulation panel 26. The interior and exterior insulation panels 24 and 26, respectively, are preferably formed of twinwall polycarbonate plastic or other expandable material so as to conform closely to the surface of the shoulder 18 of the screen window frame 14 or any other type of groove which supports the window insulation panel 16. The interior and exterior panels 24 and 26, respectively, are disposed parallel to each other and additionally generally parallel to the existing double paned window 12.

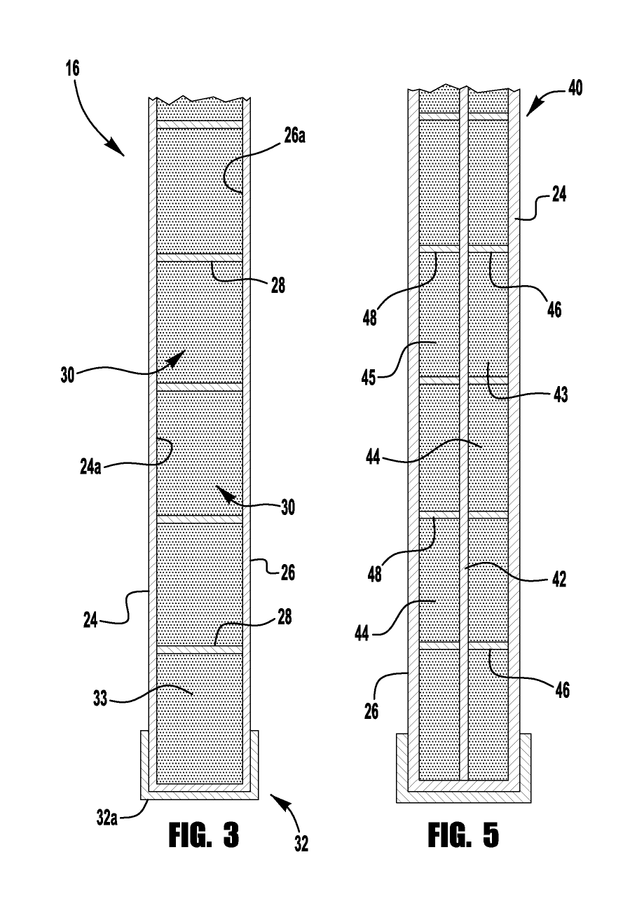

As shown in FIGS. 1 and 3, the interior and exterior insulation panels 24 and 26, respectively, window insulation panel 16 are joined by a series of lateral brackets 28 which extend from the inner surface 24a of interior insulation panel 24 to the inner surface 26a of the exterior insulation panel 26. The lateral brackets 28 are preferably equally spaced from each other. Preferably, the distance between the interior and exterior insulation panels 24 and 26, respectively, is the same as the distance between the lateral brackets 28. For example, with a distance between the interior and exterior insulation panels 24 and 26 of about 10 millimeters (mm), the lateral brackets are spaced from each other a distance of 10 mm. It is also within the terms of the invention to space the lateral brackets 28 unequal distances from each other. Moreover the lateral brackets 28 are disposed perpendicularly to the interior and exterior insulation panels 24 and 26, respectively. It is also within the terms of the present invention for the lateral brackets 28 to be disposed at any angle with respect to the interior and exterior insulation panels 24 and 26, respectively. The interior and exterior insulation panels 24 and 26, respectively and lateral brackets 28 can be constructed of polycarbonate and range in thickness from 6 mm to about 40 mm and preferably between 10 mm to 25 mm. As such, a plurality of insulation cells or chambers 30 are formed between the interior insulation panel 24, the exterior insulation panel 26, and lateral brackets 28.

The grid-like construction of the polycarbonate interior insulation panel 24, exterior insulation panel 26 and lateral brackets 28 nonetheless imbues the insulation panel section 16 with considerable shear and compressive strength and protects the enclosed aerogel 33 from potential friation. In the preferred embodiment, the total thickness of the insulation panel section 16 can be 10 mm, 16 mm, or 25 mm.

At the upper and lower ends 16a and 16b (not shown) of window insulation panel 16, the cells or chambers 30 are open and require closing and sealing after being filled with an insulator gel 33, as described hereinafter. The cell 30 can be sealed by any means such as a strip of polycarbonate, preferably of the same thickness as the insulation panels 24 and 26 or a tape, such as a common white glass cloth tape. Prior to sealing cells 34, they are filled with an aerogel 33 such as Nanogel, from Cabot Corporation of Boston, Mass.

The aerogel 33 is an extremely lightweight, translucent solid derived from a gel of various substances, wherein gas has been substituted for the typical liquid component of the gel. The aerogel 33 is formed of granular particles having a fine silicon structure; about 3% solids to 97% air; highly porous; with an R value of 8 per inch; a weight of about 0.65 lb. Per cubic foot, and hydrophobic. The resultant aerogel 33 is extremely thermally resistant against conduction, convection and radiation forms of heat; sound transmission resistant; light transmission resistant, that is, it is translucent and efficient at limiting condensed air transmission through the insulation panel 16 and therefore able to prevent condensation in the chambers 30.

Accordingly, the window insulation panel 16 is extremely effective against the passage of heat through the insulation panel. Additionally, the window insulation panel 16, being constructed of the preferred materials of polycarbonate and aerogel, is very light, and consequently easy to handle, install and remove from a window installation 10.

While the aerogel 33 in the cells or chambers 30 imbues the window insulation panel 10 generally with a translucent or dimming quality. This translucency, and the general appearance of the window insulation panel 16, can be varied to some degree by the selection of different types of aerogel 33. In addition, the interior and exterior insulation panels 24 and 26, can be constructed of a translucent or clear polycarbonate to change the degree of translucency of the window insulation panel 16. Moreover, the color of the aeogel 33 can be changed as desired.

Once the insulation panel 16 is filled with the aerogel 33 and the chambers 30 are sealed, the edges of the panel 16 can be covered with a “U” shaped channel 32, including side channels 32a and 32b, and upper and lower channels 32c (not shown) and 32d, respectively. While the channels 32 can be constructed of polycarbonate, it is within the terms of the invention to construct them of any desired material such as for example, aluminum or steel.

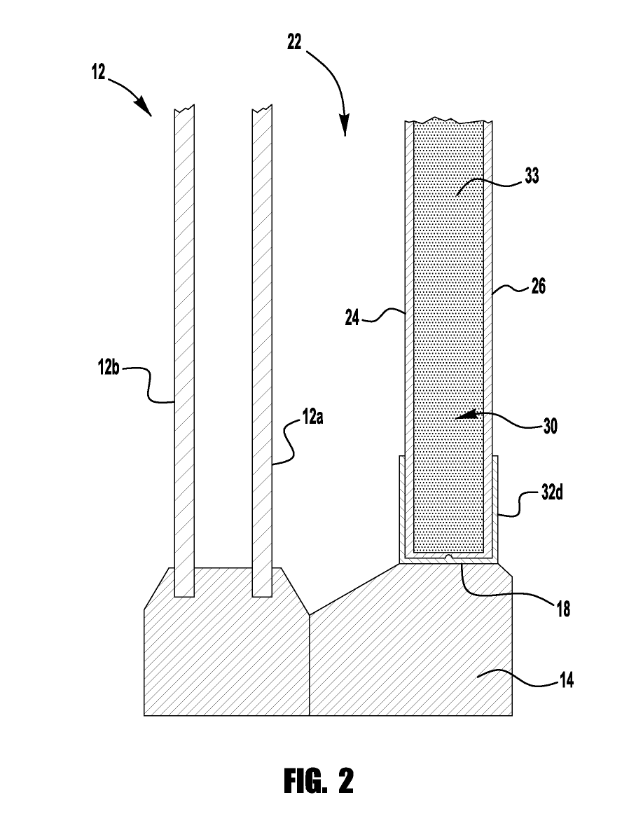

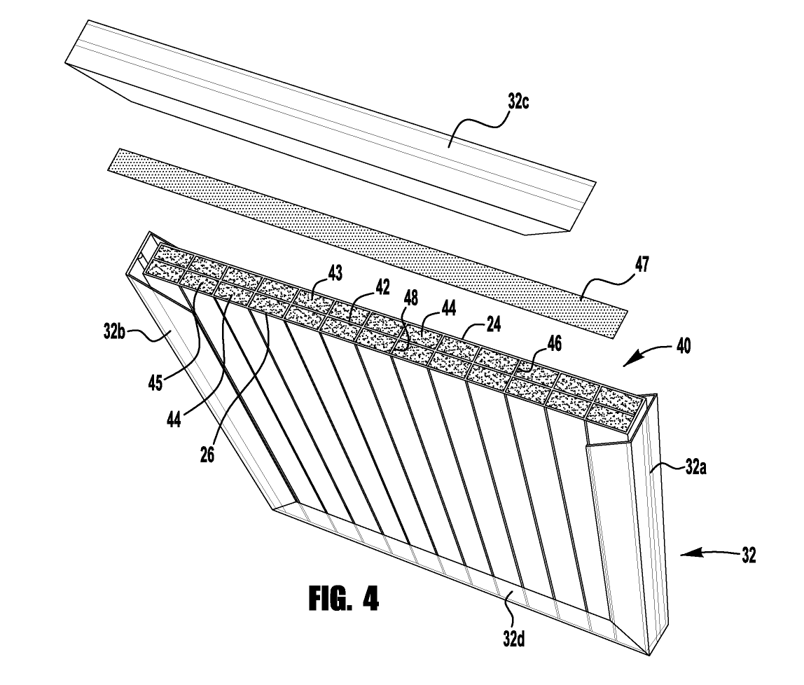

In another embodiment of the present invention, as shown in FIGS. 4 and 5, the window insulation panel 40 (compare insulation panel 16) includes an intermediate insulation panel 42 disposed medially between interior and exterior insulation panels 24 and 26, respectively. The intermediate insulation panel 42 is preferably equidistant and parallel to the interior and exterior insulation panels 24 and 26. As shown in FIGS. 4 and 5, the interior, exterior and intermediate insulation panels 24, 26 and 42, respectively, of window insulation panel 40 are joined by a series of lateral brackets 46 and 48. Lateral brackets 46 extend between the interior insulation panel 24 and the intermediate panel 42 and form cells or chambers 43. Lateral brackets 48 extend between the exterior insulation panel 26 and the intermediate insulation panel 42 and form cells or chambers 43 and 45. The lateral brackets 46 and 48 are equally spaced a distance corresponding to the thickness of the interior and exterior insulation panels 24 and 26. That is, the lateral brackets 48 are disposed to form square chambers 43 and 45 corresponding to the thickness of the panel, such as for example, 10 mm. If the panel is triple wall, it is split in half and squares are made equal to each half thickness. It is also within the terms of the invention to space the lateral brackets 46 and 48 unequal distances from each other. Moreover the lateral brackets 46 and 48 are disposed perpendicularly to the interior and exterior and intermediate insulation panels 24, 26 and 42, respectively. It is also within the terms of the present invention for the lateral brackets 46 and 48 to be disposed at any angle with respect to the interior and exterior and intermediate insulation panels 24, 26 and 42, respectively. Similar to the construction of the first embodiment illustrated in FIGS. 1, 2 and 3, the interior, exterior and intermediate insulation panels 24, 26 and 42, respectively, and lateral brackets 46 and 48 can be constructed of polycarbonate and range in thickness from 6 mm to about 40 mm and preferably between 10 mm to 25 mm.

As described with respect to the embodiment shown in FIGS. 1-3, the aerogel 44 in the cells 43 and 45 imbues the window insulation panel 40 generally with a translucent or dimming quality. This translucency, and the general appearance of the window insulation panel 40, can be varied to some degree by the composition of the aerogel 44 and/or the clearness or translucency of the interior, exterior and intermediate insulation panels 24, 26 and 42, respectively.

As described with respect to the embodiment shown in FIGS. 1-3, at the upper and lower ends 40a and 40b of window insulation panel 40, the cells or chambers 43 and 45 are open and require closing and sealing after being filled with an insulator gel 44, as described hereinafter. The cells 43 and 45 can be sealed by any means such as a strip of polycarbonate, preferably of the same thickness as the insulation panels 24 and 26 or a tape 47, such as a standard white glass cloth tape. Prior to sealing cells 43 and 45, they are filled with an aerogel 44 (compare aerogel 33 of FIGS. 1-3), such as Nanogel, from Cabot Corporation of Boston, Mass.

According to the arrangement shown in FIGS. 4 and 5, the two rows of cells 43 and 45 allow for constructions of the window insulation panel section 40 of up to about 1″ thick, while remaining durable and lightweight. This additionally thickness endows the window insulation panel 40 with even greater thermal performance. Additionally, it is within the terms of the present invention that the lateral brackets 46 and 48 and medial wall 42 may be disposed in alternative arrangements to further enhance the thermal performance of the window insulation panel 40.

Once the insulation panel 40 is filled with the aerogel 44 and the chambers 43 and 45 are sealed, the ends of the panel 40 can be covered with a channel 32, including side channels 32a and 32b, and upper and lower channels 32c and 32d, respectively. While the channels 32 can be constructed of polycarbonate, it is within the terms of the invention to construct them of any desired material such as for example, aluminum or steel.

Although the invention has been shown and described with respect to a certain preferred embodiment or embodiments, certain equivalent alterations and modifications will occur to others skilled in the art upon the reading and understanding of this specification and the annexed drawings. In particular regard to the various functions performed by the above described components (assemblies, devices, etc.) the terms (including a reference to a “means”) used to describe such components are intended to correspond, unless otherwise indicated, to any component which performs the specified function of the described component (i.e., that is functionally equivalent), even though not structurally equivalent to the disclosed structure which performs the function in the herein illustrated exemplary embodiments of the invention. In addition, while a particular feature of the invention may have been disclosed with respect to only one of several embodiments, such feature may be combined with one or more features of the other embodiments as may be desired and advantageous for any given or particular application.

In the claims:

1. A window insulation panel, comprising:
an exterior insulation panel spaced from an interior insulation panel and joined thereto;
at least one enclosed chamber disposed between the exterior and interior insulation panels; and
the at least one enclosed chamber being filled with aerogel.

2. The window insulation panel of claim 1 further including a plurality of enclosed chambers disposed between the exterior and interior insulation panels.

3. The window insulation panel of claim 2 further including a plurality of lateral brackets disposed between the exterior and interior insulation panels.

4. The window insulation panel of claim 3 wherein the plurality of lateral brackets are disposed vertically, continuously and perpendicularly to the exterior and interior insulation panels to form the plurality of enclosed chambers.

5. The window insulation panel of claim 4 wherein the lateral brackets are equally spaced from each other.

6. The window insulation panel of claim 5 wherein the lateral brackets are unequally spaced from each other.

7. The window insulation panel of claim 4 further wherein the plurality of enclosed chambers are filled with an aerogel.

8. The window insulation panel of claim 7 further wherein the plurality of enclosed chambers are filled with a silica based aerogel.

9. The window insulation panel of claim 7 wherein the aerogel is formed of granular particles having a fine silicon structure of about 3% solids to 97% air, an R value of 8 per inch, a weight of about 0.65 lb. per cubic foot, and being hydrophobic.

10. The window insulation panel of claim 9 wherein the aerogel is thermally resistant against conduction, convection and radiation forms of heat; sound transmission resistant; light transmission resistant; and moisture repellent.

11. The window insulation panel of claim 5 wherein the window insulation panel is constructed of polycarbonate and aerogel.

12. The window insulation panel of claim 5 wherein the total thickness of the insulation panel is at least about 10 mm.

13. A window insulation panel, comprising:
an exterior insulation panel spaced from an interior insulation panel;
an intermediate insulation panel disposed medially between interior and exterior insulation panels
a plurality of enclosed chambers disposed between the exterior and interior insulation panels; and
the plurality of enclosed chambers being filled with aerogel.

14. The window insulation panel of claim 13, comprising:
a first series of lateral brackets between the interior and intermediate insulation panels to form a plurality of first enclosed chambers; and
a second series of lateral brackets between the exterior and intermediate insulation panels to form a plurality of second enclosed chambers.

15. The window insulation panel of claim 14 wherein the plurality of first and second enclosed chambers are filled with an aerogel.

16. The window insulation panel of claim 15 wherein the aerogel is formed of granular particles having a fine silicon structure of about 3% solids to 97% air, an R value of 8 per inch, a weight of about 0.65 lb. per cubic foot, and being hydrophobic.

17. A method of constructing a window insulation panel, comprising:
joining an exterior insulation panel in spaced relationship to an interior insulation panel;
forming at least one enclosed chamber between the exterior and interior insulation panels; and
filling the at least one enclosed chamber being filled with aerogel.

18. The method of claim 17 further including providing a plurality of enclosed chambers between the exterior and interior insulation panels.

19. The method of claim 18 further including filling the plurality of enclosed chambers are filled with aerogel formed of granular particles having a fine silicon structure of about 3% solids to 97% air, an R value of 8 per inch, a weight of about 0.65 lb. per cubic foot, and being hydrophobic.

20. The method of claim 19 including closing and sealing the chambers after being filled with an insulator gel; and covering the edges of the insulation panel with channels.
